(19) United States
(12) Patent Application Publication
(10) Pub. No.: US 2010/0067687 A1
(43) Pub. Date: Mar. 18, 2010

(54) METHOD AND APPARATUS FOR MAINTAINING DATA INTEGRITY FOR BLOCK-ENCRYPTION ALGORITHMS

(75) Inventors: Rajarathnam Chandramouli, Holmdel, NJ (US); Chetan Nanjunda Mathur, Hoboken, NJ (US)

Correspondence Address: GREENBERG TRAURIG, LLP, 200 PARK AVE., P.O. BOX 677, FLORHAM PARK, NJ, 07932, US

(73) Assignee: THE TRUSTEES OF THE STEVENS INSTITUTE OF TECHNOLOGY, Hoboken, NJ (US)

(21) Appl. No.: 11/792,282

(22) PCT Filed: Dec. 1, 2005
(86) PCT No.: PCT/US2005/043576

§ 371 Date: Nov. 30, 2009

Related U.S. Application Data
(60) Provisional application No. 60/633,666, filed on Dec. 6, 2004.

(51) Int. Cl. H04L 9/34

(52) U.S. Cl. 380/37; 380/29

(57) ABSTRACT

A method is disclosed for modifying an iterated block cipher by controlling the operations and transformations that cause diffusion. In one embodiment which is applicable to any iterated block cipher (12), a diffusion function (10), during encryption, is selected based on a parameter which measures the order of permutation of the diffusion function (10) and applies the diffusion function (10) to the encryption routine (12). The user chooses the required amount of diffusion for a given block of plaintext (11). The plaintext (11) is then encrypted using the modified diffusion function (10) to produce a ciphertext (14) which is then sent over a communications channel (16) which may be noisy. At the receiving end (18) of the communications channel (16), the received ciphertext (20), which now may be corrupted by bit errors, is passed through an iterated block cipher decryption routine (22) using the same diffusion function (10) selected earlier during encryption. In a second embodiment, the SCOPE method is applied to the DES encryption and decryption standard. The expansion bits (82) of DES are replaced with a minicipher (98a-98n), and the DES standard permutation box (88) is replaced with a permutation box (104a-104n) modified according to a user-specified order of permutation. In a third embodiment, the SCOPE method is applied to the AES encryption and decryption standard. In the SCOPE-enhanced version of AES, diffusion is controlled by altering the diffusion of the “MixColumn” or “InvMixColumn” transformation based on its branch number and by changing the number of shifts in the “ShiftRow” or “InvShfitRow” transformations.

### CROSS-REFERENCE TO RELATED APPLICATIONS

This application claims the benefit of U.S. provisional patent application No. 60/633,666 filed Dec. 6, 2004, the disclosure of which is incorporated herein by reference in its entirety.

### TECHNICAL FIELD OF THE INVENTION

The present invention relates to data encryption and/or decryption, and, more particularly, to a method and apparatus for reducing the susceptibility of block-encrypted data transmitted over noisy networks to transmission channel induced bit errors.

### BACKGROUND ART

Wireless networks have replaced wired networks both at offices and the home. The cellular market has also grown swiftly, with more people preferring mobile communication. Although wireless networks and mobile devices add flexibility to the lives of people, they have at least two serious drawbacks: wireless communication is subject to intrusion and prone to interference from noisy channels of transmission. To handle the intrusion problem, designers of wireless networks have employed various techniques such as cryptography.

One popular cryptographic technique known in the art is block ciphering. In block ciphering, a source block of data known as a plaintext (e.g. a block of 64 bits) is operated upon to produce an encrypted version of the block, referred to as ciphertext. This process is carried out for each bock of source data. Three common properties of block ciphers are the use of key mixing, confusion, and diffusion. Key mixing involves operations that make the ciphertext dependent on both the plaintext and a secret key. Confusion involves substituting one or more groups of bits or bytes of data for another, via a transformation of one set of bits or bytes for another. This operation makes the relationship between the statistics of the ciphertext and the value of the encryption key as complex as possible in order to thwart key discovery. This makes it difficult to utilize a statistical analysis to narrow the search to find the key. Confusion ensures that most of the key is needed to decrypt even very short sequences of ciphertext. Confusion is usually achieved by a substitution operation. Diffusion involves operations and transformations that smooth out the statistical differences between characters and between character combinations. The statistical structure of the plaintext dissipates into long range statistics of the ciphertext. Diffusion is usually achieved by a permutation operation.

The key mixing, substitution (confusion), and permutation (diffusion) operations described above achieve a property known as avalanche effect. The avalanche effect can be described as the property that a minor change to the plaintext or the key results in significant changes to the ciphertext that appear to be random. For a given transformation to exhibit the avalanche effect, an average of one half of the output bits should change whenever a single input bit changes.

Most block ciphers are constructed by repeatedly applying a function to the plaintext and/or ciphertext. This approach is known as iterated block cipher. Each iteration is termed a round, and the repeated function is termed the round function f. The round function f is applied iteratively for several rounds. The round function f combines the key mixing, substitution, and permutation operations discussed above. Iterated block ciphers strongly exhibit the avalanche effect in order to maximize the security of the ciphertext against intrusion.

Unfortunately, the very same properties that give iterated block ciphers their cryptographic strength (e.g., the avalanche effect) make them sensitive to channel errors. For example, in iterated block ciphers, a single bit flip in the encrypted data can cause a complete decryption failure, in which the error is propagated or spread throughout the ciphertext block by the avalanche effect. In many iterated block ciphers, this propagation of errors is made worse when the ciphertext of the current block is partially based on the ciphertext generated in a previous block. This results in errors from previous blocks cascading though subsequent blocks. The sensitivity of iterated block ciphers to propagation of errors makes error-free transmission in noisy channels, such as wireless networks, very difficult to achieve. An error prone transmission channel is subject to frequent retransmissions of blocks, which reduces overall throughput, and in the case of mobile phones or radios, drains battery power.

### DISCLOSURE OF THE INVENTION

The present invention overcomes the disadvantages and shortcomings of the prior art discussed above by providing a method for maintaining data integrity for a block of data to be transmitted over a communications channel by modifying an iterated block cipher to control the operations and transformations that cause diffusion. This method is referred to herein as Robust Encryption Based Security by Controlled Propagation of Errors (SCOPE). The encryption method according to the present invention includes the steps of receiving a block of data to be encrypted; selecting an iterated block cipher encryption algorithm to be applied to the block of data; determining a desired amount of diffusion specified by a user; selecting a diffusion function corresponding to the desired amount of diffusion; and encrypting the block of data using the iterated block cipher encryption algorithm and the diffusion function to produce a cipher text for transmission over the communications channel.

The diffusion function, during encryption, is selected based on a parameter which measures the order of permutation of the diffusion function and applies the diffusion function to the encryption routine. The user chooses the required amount of diffusion for a given block of plaintext. The plaintext is then encrypted using the modified diffusion function to produce a ciphertext which is then sent over a communications channel which may be noisy. At the receiving end of the channel, the received ciphertext, which now may be corrupted by bit errors caused by noise in the communications channel, is passed through an iterated block cipher decryption routine using the same diffusion function generated earlier. The decryption method according to the present invention includes the steps of receiving a block of ciphertext to be decrypted; selecting an iterated block cipher decryption algorithm to be applied to the block of ciphertext, the iterated block cipher decryption algorithm having been modified by a diffusion function corresponding to a desired amount of diffusion used during encryption; and decrypting the block of ciphertext using the iterated block cipher decryption algorithm and the diffusion function to produce a block of plaintext.

In a second embodiment, the SCOPE method is applied to the DES encryption and decryption standard. The expansion bits of DES are replaced with a minicipher, and the DES standard permutation box is replaced with a permutation box modified according to a user-specified order of permutation.

In a third embodiment, the SCOPE method is applied to the AES encryption and decryption standard. In the SCOPE-enhanced version of AES, diffusion is controlled by altering the diffusion of the “MixColumn” or “InvMixColumn” transformations based on its branch number and by changing the number of shifts in the “ShiftRow” or “InvShiftRow” transformations.

Further features and advantages of the invention will appear more clearly on a reading of the following detailed description of three exemplary embodiments of the invention.

### BRIEF DESCRIPTION OF THE DRAWINGS

For a more complete understanding of the present invention, reference is made to the following detailed description of three exemplary embodiments considered in conjunction with the accompanying drawings, in which:

FIG. 1 is a block diagram showing the application of the SCOPE method to a generic iterated block cipher in accordance with an exemplary embodiment of the present invention;

FIG. 2 is a flow chart of the method depicted in FIG. 1;

FIG. 3 is a block diagram showing a complete encryption of a block of data using the standard DES encryption algorithm;

FIG. 4 is a block diagram showing a standard building block of the DES Processing Module of FIG. 3 in greater detail;

FIG. 5 is a block diagram showing a complete decryption of a block of data using the standard DES decryption algorithm;

FIG. 6 is a block diagram showing the SCOPE method of the present invention applied to a DES block cipher, in accordance with another embodiment of the present invention;

FIG. 7 is a flow chart of the method depicted in FIG. 6;

FIG. 8 is a flow chart showing step 120 of FIG. 7 in greater detail, wherein minicipher output bits are generated;

FIG. 9A is a graphical representation showing permutation of sub-sub-blocks of a 64-bit plaintext of a DES-like iterated block cipher modified in accordance with the present invention, using a random permutation generator with the permutation order α=1;

FIG. 9B is a graphical representation showing permutation of sub-sub-blocks of a 64-bit plaintext of a DES-like iterated block cipher modified in accordance with the present invention, using a random permutation generator with the permutation order α=2;

FIG. 9C is a graphical representation showing permutation of sub-sub-blocks of a 64-bit plaintext of a DES-like iterated block cipher modified in accordance with the present invention, using a random permutation generator with the permutation order α=3;

FIG. 9D is a graphical representation showing permutation of sub-sub-blocks of a 64-bit plaintext of a DES-like iterated block cipher modified in accordance with the present invention, using a random permutation generator with the permutation order α=4;

FIG. 10 is a flow chart showing the steps of the SCOPE method as applied to an AES encryption procedure;

FIG. 11 is a flow chart showing the modified Round function of step 176 of FIG. 10 in greater detail;

FIG. 12A is a graphical representation showing transformation of sub-sub-blocks of one column of the State matrix of an AES-like iterated block cipher using a MixColumn transformation modified in accordance with the present invention with the permutation order α=4;

FIG. 12B is a graphical representation showing transformation of sub-sub-blocks of one column of the State matrix of an AES-like iterated block cipher using a MixColumn transformation modified in accordance with the present invention with the permutation order α=2;

FIG. 13 is a flow chart showing the steps of the SCOPE method as applied to an AES decryption procedure;

FIG. 14 is a flow chart showing the modified InvRound function of step 236 of FIG. 13 in greater detail;

FIG. 15 is a block diagram of an apparatus capable of employing the SCOPE method of the present invention;

FIG. 16 is a plot of post-decryption bit error rate (BER) vs. pre-decryption BER showing the performance of different permutation orders for a SCOPE-modified DES cipher and a traditional DES cipher; and

FIG. 17 is a plot of post-decryption bit error rate (BER) vs. pre-decryption BER showing the performance of different permutation orders for a SCOPE-modified AES cipher and a traditional AES cipher with and without the presence of channel coding.

### BEST MODE FOR CARRYING OUT THE INVENTION

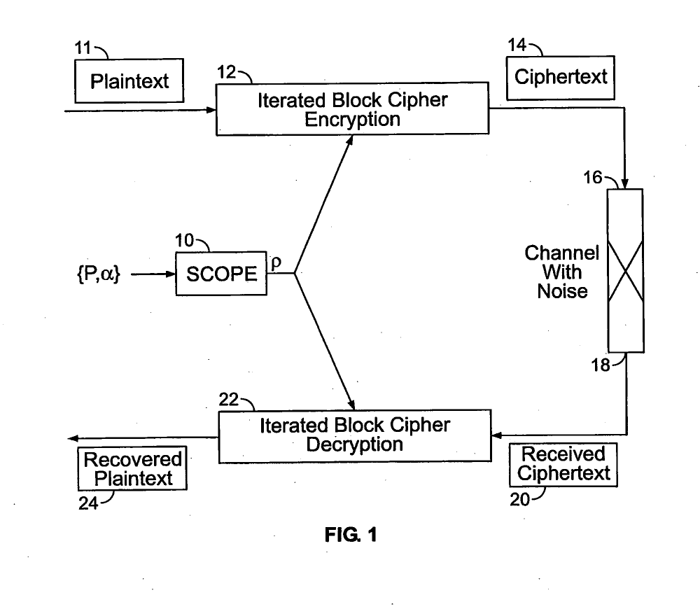

With reference to FIG. 1, there is shown the SCOPE method of the present invention, indicated generally at 10. The SCOPE method 10 operates in conjunction with an iterated block cipher encryption procedure 12 on one or more blocks of plaintext 11 to produce an encrypted ciphertext 14. During encryption, a diffusion function ρ is selected from the set of all diffusion/permutation functions P based on a parameter α, where α measures the amount of diffusion (i.e., order of permutation) of the function ρ. The selected diffusion function ρ is then applied by the encryption routine 12 to the plaintext 11. The user can choose the desired amount of diffusion α for a given block of plaintext 11. The value of α and, hence, the diffusion function ρ can change from block to block of the plaintext 11. In this way, the amount of diffusion in ρ is controlled on a block-by-block basis of the plaintext 11 so as to control the amount of avalanche effect induced by the round function f applied to the plaintext 11 by the encryption routine 12. The ciphertext 14 produced by the encryption routine 12 is then transmitted through a noisy channel 16, which can be any communication medium such as a wired link (e.g., a local area network), a wireless link (e.g., the air medium between a cellular phone and a base station), a hard disk in a computer system, a CD-ROM in a computer system, etc. At the receiving end 18 of the noisy channel 16, the received ciphertext 20, which now may be corrupted by bit errors resulting from noise or other disruptions on the communications channel 16, is passed through an iterated block cipher decryption routine 22 using the same diffusion function ρ selected earlier by the SCOPE method 10. The recovered plaintext 24 emerges from the decryption routine 22. The recovered plaintext 24 will have fewer “avalanche effect” induced errors than recovered plaintext which was encoded without using the SCOPE method.

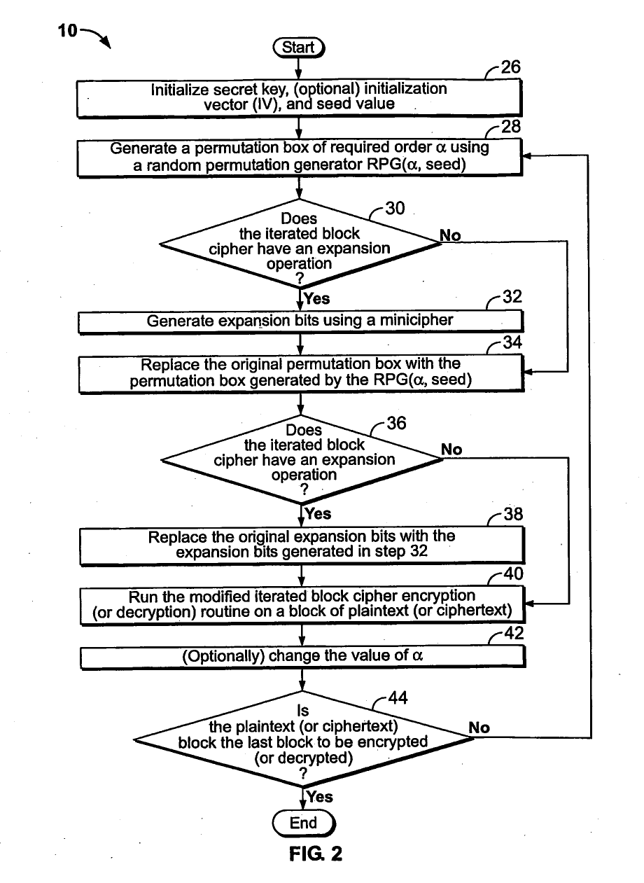

With reference to FIG. 2, the SCOPE method 10 of FIG. 1, as applied to both encryption and decryption, is shown in greater detail. More particularly, at step 26, a secret key, an optional initialization vector (IV), and a seed value are initialized to an appropriate set of values. An initialization vector is a random set of bits or bytes required by some iterated block encryption or decryption algorithms to begin the first round of iteration of the encryption or decryption routine. A seed value is a changing numerical value, such as the current time, that is used to generate a random set of numbers, in this case a random permutation generator to be discussed hereinbelow. At step 28, a permutation box of required order α is generated using the random permutation generator that was initialized with the seed value of step 26. At step 30, if the encryption or decryption routine is to be applied to an iterated block cipher with an expansion operation, then at step 32, expansion bits are generated using a minicipher to be discussed hereinbelow. At step 34, the original permutation box of the unaltered encryption or decryption algorithm is replaced with the permutation box generated by the random permutation generator of step 28. At step 36, if the encryption or decryption routine is to be applied to an iterated block cipher with an expansion operation, then at step 38, the original expansion bits of the unaltered encryption or decryption algorithm are replaced with the expansion bits generated in step 32. At step 40, the modified iterated block cipher encryption or decryption routine is run on a block of plaintext or ciphertext. Optionally, at step 42, the value of α can be changed if communications channel noise conditions change. At step 44, if the plaintext or ciphertext block is the last block to be encrypted or decrypted, then the algorithm stops; otherwise, at step 46, the algorithm returns to step 28 above to process additional blocks.

The Data Encryption Standard (DES) is a representative iterated block encryption standard that can benefit from modification to its expansion and permutation operations using the SCOPE method of the present invention. A representative description of DES is set forth in Data Encryption Standard, National Bureau of Standards, U.S. Department of Commerce, 1977, which can be found at the web site http://www.itl.nist.gov/fipspubs/fip46-2.htm and which is incorporated herein by reference in its entirety. DES can be regarded as a block encryption/decryption system with an alphabet size of 2⁶⁴ symbols.

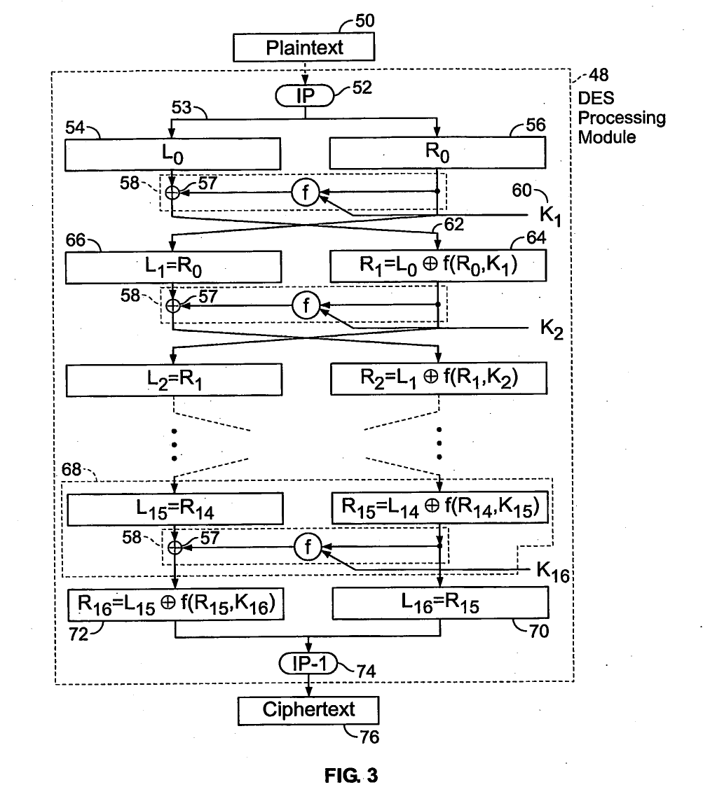

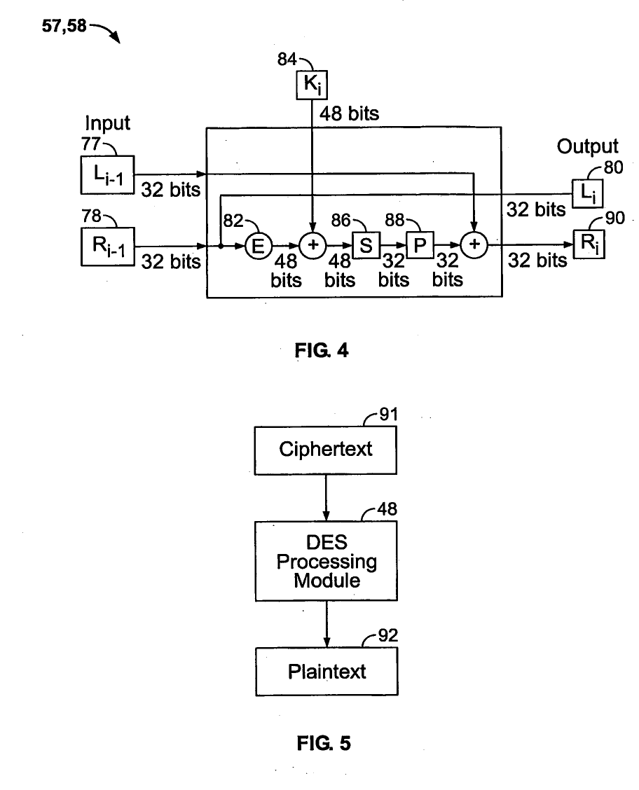

With reference to FIG. 3, there is shown a block diagram of the procedure for encrypting a block using the existing DES standard, as is known in the art. In the first step performed within a DES processing module 48, an input block of sixty-four bits, known as plaintext 50, is passed through an initial permutation operation 52, where the initial permutation operation 52 is described in a standard permutation table. After the initial permutation operation 52 is performed, the 64-bit data is passed through the first round of the DES processing module 48. In the first round, the 64-bit data 53 is divided into two 32-bit sub-blocks L₀ and R₀, which are specified as a left-half sub-block 54 and a right-half sub-block 56, respectively. A standard building block 58, which includes the round function f, is applied to the right-half sub-block 56. The left-half sub-block 54, is modulo-2 summed in a modulo-2 summing block 57 with the output of the round function f. When the standard building block 58 is applied to the 32-bit right-half sub-block 56, the data of the right-half sub-block 56 passes through expansion, substitution, and permutation operations, modified by a portion of the secret key K₁, (labeled as 60), which is described in more detail hereinbelow with reference to FIG. 4. The modulo-2 summed output 62 is transposed to become the right-half sub-block 64 for the next round, while the right-half sub-block 56 is transposed to become the left-half sub-block 66 for the next round 64 of the algorithm. The steps of applying the round function f, modulo-2 summing, and transposing are repeated for 14 more rounds. With the completion of the last round 68, the left-half sub-block 70 (labeled L₁₆) and the right-half sub-block 72 (labeled R₁₆) are not transposed, but are combined and passed through a final inverse permutation block 74, described in another standard table. The output of the inverse permutation block 74 is a block of ciphertext 76. The DES processing module 48 then operated on subsequent blocks of plaintext to produce block of ciphertext.

With reference to FIG. 4, there is shown the standard building block 58, (i.e., including the round function t) and the modulo-2 summing block 57 in greater detail. Thirty-two bit sub-blocks 77, 78, labeled Lₗ₋₁ and Rₗ₋₁, respectively, are the transposed outputs of a previous round. The input right-half thirty-two bit sub-block 78 is copied unchanged to become the output left half thirty-two bit sub-block 80, labeled Lₗ. The input left right thirty-two bit sub-block 78 passes through a series of steps of (i) expansion 82 from thirty-two bits to forty-eight bits using an E-table (expansion rule table), (ii) modulo-two summing with a forty-eight bit portion 84 of a secret key, (iii) substitution with an S-box 86 (substitution rule table) taken from a standard table which takes the expanded the forty-eight bits and retransforms it back into a thirty-two bit sub-block, (iv) permutation 88 taken through a P-table, and (v) modulo-two summing with the thirty-two bit left-half sub-block 77 to produce the right half thirty-two bit sub-block 90.

In the expansion operation, the thirty-two bit sub-block 78, represented by A(a₁, a₂, . . . , a₃₂) where each aᵢ represents a bit at a position i, is divided into eight, four bit, sub-sub-blocks (A₁, A₂, . . . , A₈), where A₁ is a₁a₂a₃a₄, A₂ is a₅, a₆, a₇, a₈, and A₈ is a₂₉, a₃₀, a₃₁, a₃₂. The expansion operation 82 converts each four bit, sub-sub-block into a six bit sub-sub-block by appending the four bit sub-sub-block at both ends with bits from its neighboring sub-sub-blocks by the relation EXP(A)=(a₃₂, a₁, a₂, a₃, a₄, a₅, . . . , a₂₈, a₂₉, a₃₀, a₃₁, a₃₂, a₁). This produces the aforementioned avalanche effect. By appending bits from other sub-sub-blocks to a given sub-sub-block, a form of diffusion is accomplished, but with the side effect of increasing vulnerability to avalanche-effect bit errors. Likewise, the permutation operation 88 subjects the thirty-two bit sub-block 78 to avalanche-effect bit errors.

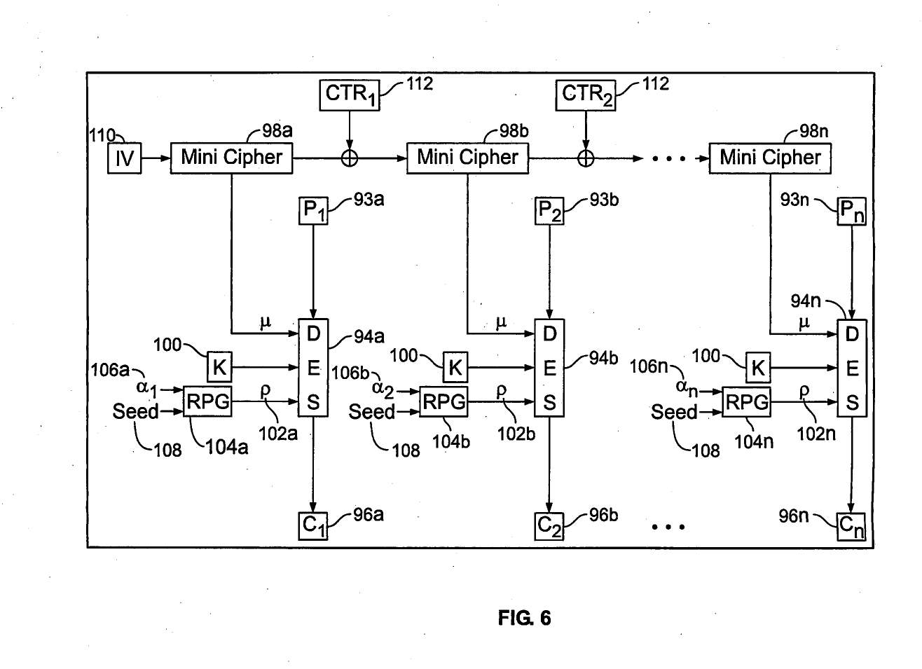

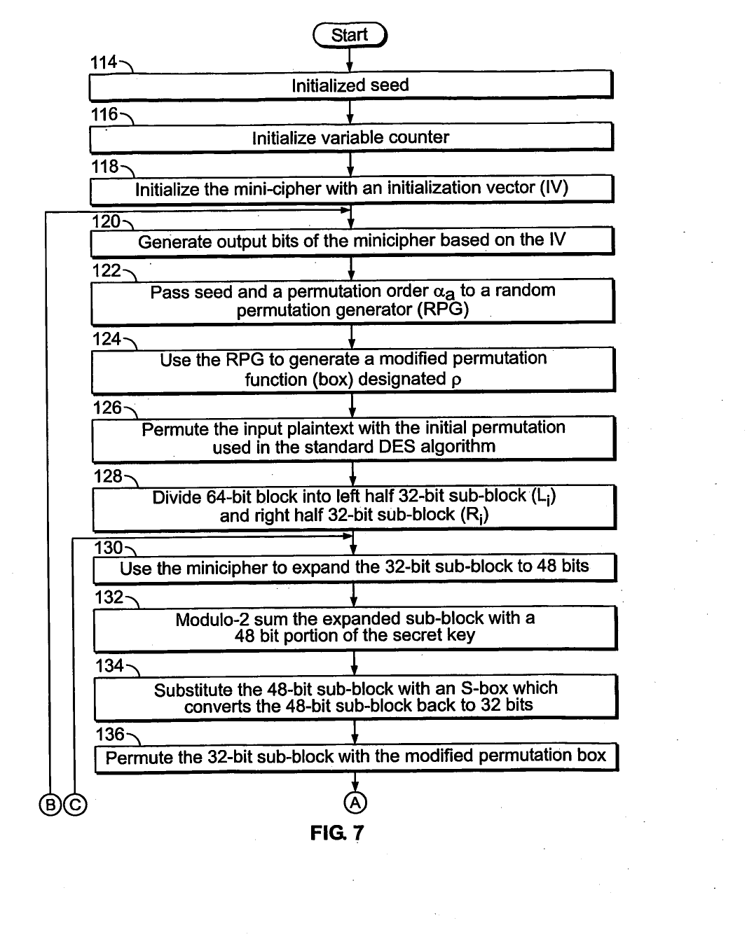

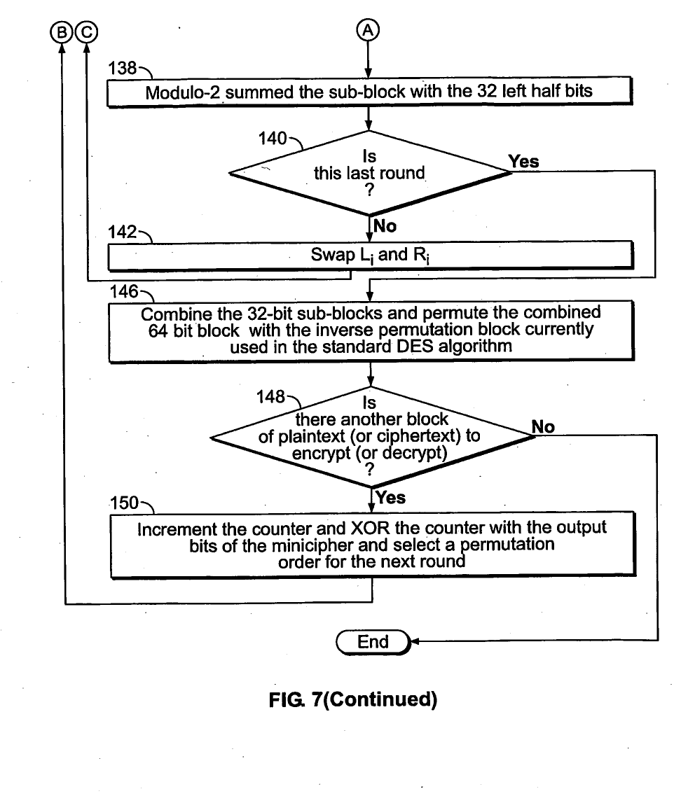

When the method of the present invention is applied to DES, both the expansion operation 82 and the permutation operation 88 are modified to control a sub-sub-block's dependency on bits from other sub-sub-blocks so that the number of subsequent substitution boxes at round r+1 affected by the output bits of the current substitution box 86 at round r are controlled. Control of the expansion operation 82 is accomplished by substituting the normal expansion operation 82 (E-table) with a minicipher, and using a value of an order of permutation α for generating a modified permutation operation 88 (P-table), both to be discussed hereinbelow in connection with FIGS. 6 and 7.

With reference to FIG. 5, a block diagram for decryption of the standard DES algorithm is depicted. The DES decryption algorithm is essentially the reverse of the encryption algorithm shown in FIG. 3, except that the input to the DES processing block 48 is a 64-bit block of ciphetext 91, and the output of DES processing block 48, is a 64-bit block of plaintext 92.

With reference to FIG. 6, the SCOPE method of the present invention is shown as applied to DES and depicted in block diagram form. Blocks of plaintext 93a-93n are passed to modified DES blocks 94a-94n to produce blocks of ciphertext 96a-96n. A minicipher 98a-98n, designated μ, an encryption key 100, designated K, and a modified permutation operation 102a-102n, designated ρ, are applied to a corresponding one of the DES processing blocks 94a-94n. Random permutation generators (RPGs) 104a-104n generate the modified permutation operations 102a-102n based on orders of permutation 106a-106n, designated α₁-αₙ, and a seed 108. Each of the orders of permutation 106a-106n may or may not be the same for each block of plaintext 92a-92n, but remains unchanged for the same DES processing block 94a-94n for every round r. The minicipher 98a is initialized with a 16 bit initialization vector (IV) 110, which is a random set of bits. Between encryptions of each of the blocks of plaintext 92a-92n, a variable counter 112, designated CTRᵢ, is initialized to a constant value and then incremented between blocks.

Now referring to FIGS. 1 and 6, the SCOPE DES decryption algorithm is essentially the reverse of the encryption algorithm, with the ciphertext blocks 96a-96n being switched with the plaintext blocks 93a-93n, so that the ciphertext blocks 96a-96n become the inputs to the DES processing blocks 94a-94n, and the plaintext blocks 93a-93n become the outputs of the DES processing blocks 94a-94n. The initialization vector (IV) 110, the seed 108, the key 100, the permutation orders 106a-106n, and the initial counter value 112 (CTR₁) are shared with or passed to the iterated block cipher decryption procedure 22 from the iterated block cipher encryption procedure 12.

With reference to FIGS. 6 and 7, there is shown a flow chart of the steps of the SCOPE method applied to a DES encryption or decryption procedure. For the purposes of illustration, the procedure is described only for elements 93a, 94a, 96a, 98a, 102a, 104a, and 106a, but the procedure is identical for other elements (b . . . n). At step 114, the seed 108 is initialized to a value between 0 and 2¹⁶−1. At step 116, the variable counter (CTR₁) 112 is initialized to a constant value. At step 118, the minicipher (g) 98a is initialized with the initialization vector (IV) 110. At step 120, the output bits of the minicipher 98a are generated based on the initialization vector (IV) 110. At step 122, the seed 108 and the permutation order 106a, designated α₁, are passed to the random permutation generator (RPG) 104a. At step 124, the random permutation generator (RPG) is used to generate a modified permutation operation 102a, designated ρ. At step 126, the input plaintext (or ciphertext) 93a is permuted with the initial permutation used in the standard DES algorithm. At step 128, the 64-bit input plaintext (or ciphertext) 93a block is divided into left half 32-bit sub-block Lₗ and right half 32-bit sub-block Rₗ. At step 130, the minicipher 98a is used, instead of the DES standard expansion method to expand sub-sub-blocks from thirty-two bits to forty-eight bits, as is currently done in the standard DES algorithm. At step 132, the forty-eight bit expanded sub-block is modulo-two summed with a forty-eight bit portion of the secret key 100 as is currently done in the standard DES algorithm. At step 134, the forty-eight bit sub-block is substituted with an S-box which converts the forty-eight bit sub-block back to thirty-two bits as is currently done in the standard DES algorithm. At step 136, the thirty-two bit sub-block is permuted with the modified permutation operation 102a. At step 138, the sub-block is modulo-two summed with the thirty-two left half bits. At step 140, if this is not the last round (the sixteenth), then at step 142, swap Lₗ and Rₗ and repeat steps 130-138. Then, at step 146, if this is the last round, the two 32-bit sub-blocks are combined and entire sixty-four bit block is permuted with the inverse permutation block currently used in the standard DES algorithm. At step 148, if there are other blocks of plaintext (or ciphertext) to encrypt (or decrypt), then at step 150, the counter 112 (CTR₁) is incremented and is exclusive-OR'd (XORed) with the output bits of the minicipher to form a new initialization vector (IV) that is used to initialize the minicipher and a permutation order is selected for the next block to be encrypted (or the next permutation order passed from the encryption procedure to the decryption procedure is selected for the next block to be decrypted). Then each of the remaining plaintext (or ciphertext) blocks 93b-93n would be encrypted (or decrypted) by repeating steps 120-150 for each plaintext (or ciphertext) block using the remaining procedures in FIG. 7.

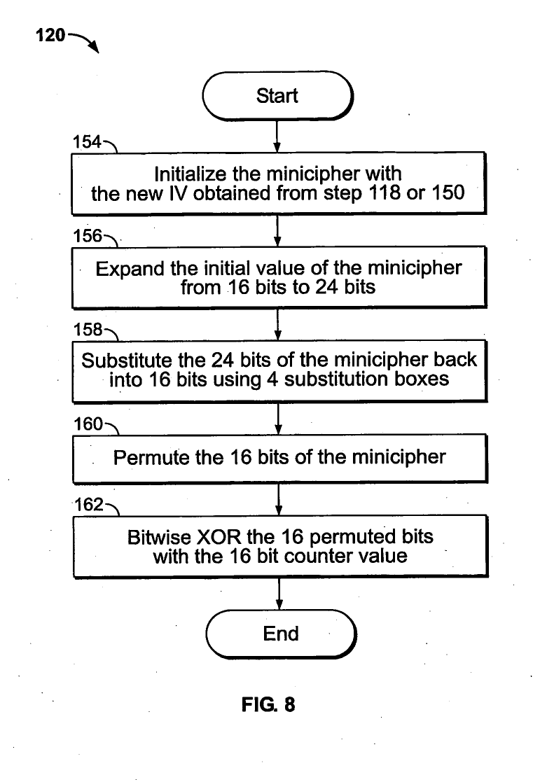

With reference to FIG. 8, the generation of the minicipher output bits in step 120 of FIG. 7 is shown in greater detail. At step 154, the minicipher is initialized with the new initialization vector (IV) obtained from step 118 or 150 of FIG. 7. At step 156, the initial value of the minicipher is expanded from sixteen bits to twenty-four bits by using an expansion box similar to the DES expansion box. At step 158, the twenty-four bits undergo a substitution back into sixteen bits using four substitution boxes similar to the DES substitution boxes. At step 160, the sixteen bits are permuted using a permutation table similar to the DES permutation table. At step 162, the sixteen permuted bits are bitwise exclusive-OR'd (XORed) with the sixteen bit counter value 112 (e.g., CTR₁). Sample expansion/substitution/permutation boxes for generating a minicipher are listed hereinbelow:

MiniCipher
Substitution Box
Sbox 1

| | | | | | | | | | | | | | | | |
|---|---|---|---|---|---|---|---|---|---|---|---|---|---|---|---|
| 14 | 4 | 13 | 1 | 2 | 15 | 11 | 8 | 3 | 10 | 6 | 12 | 5 | 9 | 0 | 7 |
| 0 | 15 | 7 | 4 | 14 | 2 | 13 | 1 | 10 | 6 | 12 | 11 | 9 | 5 | 3 | 8 |
| 4 | 1 | 14 | 8 | 13 | 6 | 2 | 11 | 15 | 12 | 9 | 7 | 3 | 10 | 5 | 0 |
| 15 | 12 | 8 | 2 | 4 | 9 | 1 | 7 | 5 | 11 | 3 | 14 | 10 | 0 | 6 | 13 |

Sbox 2

| | | | | | | | | | | | | | | | |
|---|---|---|---|---|---|---|---|---|---|---|---|---|---|---|---|
| 15 | 1 | 8 | 14 | 6 | 11 | 3 | 4 | 9 | 7 | 2 | 13 | 12 | 0 | 5 | 10 |
| 3 | 13 | 4 | 7 | 15 | 2 | 8 | 14 | 12 | 0 | 1 | 10 | 6 | 9 | 11 | 5 |
| 0 | 14 | 7 | 11 | 10 | 4 | 13 | 1 | 5 | 8 | 12 | 6 | 9 | 3 | 2 | 15 |
| 13 | 8 | 10 | 1 | 3 | 15 | 4 | 2 | 11 | 6 | 7 | 12 | 0 | 5 | 14 | 9 |

Sbox 3

| | | | | | | | | | | | | | | | |
|---|---|---|---|---|---|---|---|---|---|---|---|---|---|---|---|
| 10 | 0 | 9 | 14 | 6 | 3 | 15 | 5 | 1 | 13 | 12 | 7 | 11 | 4 | 2 | 8 |
| 13 | 7 | 0 | 9 | 3 | 4 | 6 | 10 | 2 | 8 | 5 | 14 | 12 | 11 | 15 | 1 |
| 13 | 6 | 4 | 9 | 8 | 15 | 3 | 0 | 11 | 1 | 2 | 12 | 5 | 10 | 14 | 7 |
| 1 | 10 | 13 | 0 | 6 | 9 | 8 | 7 | 4 | 15 | 14 | 3 | 11 | 5 | 2 | 12 |

Sbox 4

| | | | | | | | | | | | | | | | |
|---|---|---|---|---|---|---|---|---|---|---|---|---|---|---|---|
| 7 | 13 | 14 | 3 | 0 | 6 | 9 | 10 | 1 | 2 | 8 | 5 | 11 | 12 | 4 | 15 |
| 13 | 8 | 11 | 5 | 6 | 15 | 0 | 3 | 4 | 7 | 2 | 12 | 1 | 10 | 14 | 9 |
| 10 | 6 | 9 | 0 | 12 | 11 | 7 | 13 | 15 | 1 | 3 | 14 | 5 | 2 | 8 | 4 |
| 3 | 15 | 0 | 6 | 10 | 1 | 13 | 8 | 9 | 4 | 5 | 11 | 12 | 7 | 2 | 14 |

Expansion Box

| | | | | | | | | | | | |
|---|---|---|---|---|---|---|---|---|---|---|---|
| 16 | 1 | 2 | 3 | 4 | 5 | 4 | 5 | 6 | 7 | 8 | 9 |
| 8 | 9 | 10 | 11 | 12 | 13 | 12 | 13 | 14 | 15 | 16 | 1 |

Permutation Box

| | | | | | | | | | | | | | | | |
|---|---|---|---|---|---|---|---|---|---|---|---|---|---|---|---|
| 6 | 10 | 13 | 7 | 9 | 11 | 3 | 2 | 1 | 4 | 16 | 8 | 15 | 12 | 14 | 5 |

For the sixty-four bit DES iterated block cipher algorithm, there are four possible values, of the order of permutation, represented by α=1, 2, 3, 4. When α=4, maximum security is desired so that the default DES algorithm is used. An α of 1 deviates the most from standard DES, with maximum immunity to bit errors but minimum security. The value α can be selected as desired by a user, but it may also be defined mathematically, as follows. At round r of the encryption performed on a sixty-four bit block of plaintext using the method of the present inventions as it applies to DES, the set of four bit sub-sub-blocks Aᵢ^{r} where i=1 to 8 are expanded to a set of six bit sub-sub-blocks Bᵢ^{r} using the expansion operation of step 130 of FIG. 7 to produce the forty-eight bit sub-block B^{r}. B^{r} is then XORed with a 48-bit sub-key and substituted back to a set of four bit Cₜ^{r}'s using the substitution step 134 of FIG. 7 to produce the thirty-two bit sub-block C^{r}. The relationship Cᵢ^{r}^{₁}→Bᵢ^{r}^{ₛ} is defined to be true when a change in one or more bits in Cₗ^{r}^{₁} will change one or more bits of Bᵢ^{r}^{ₛ} with a probability p>0 where r₁ and r₂ are different rounds of the DES cipher. If Πᵢ^{r} is the set {Bⱼ^{r+1}s.tCᵢ^{r}→Bⱼ^{r+1} is true}, then the order of permutation a for the four bit Cᵢ^{r} is defined as the cardinality of the set Πᵢ^{r}. If all the i's in Cᵢ^{r} of round r satisfy the same order α, then the permutation order of the permutation box used in round r is α.

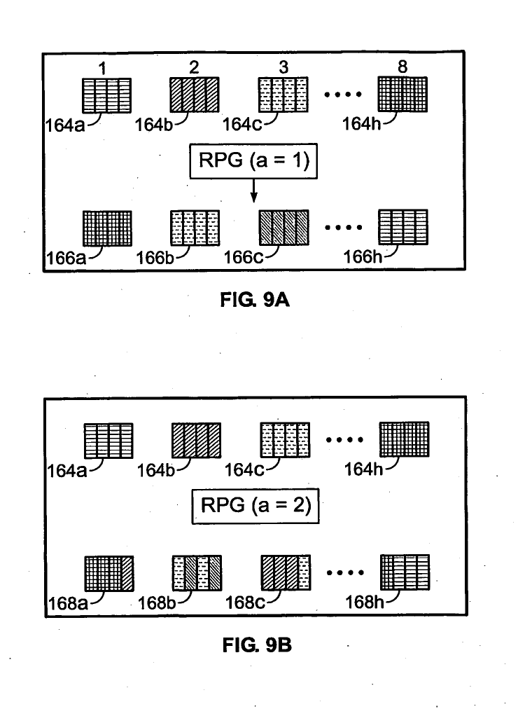

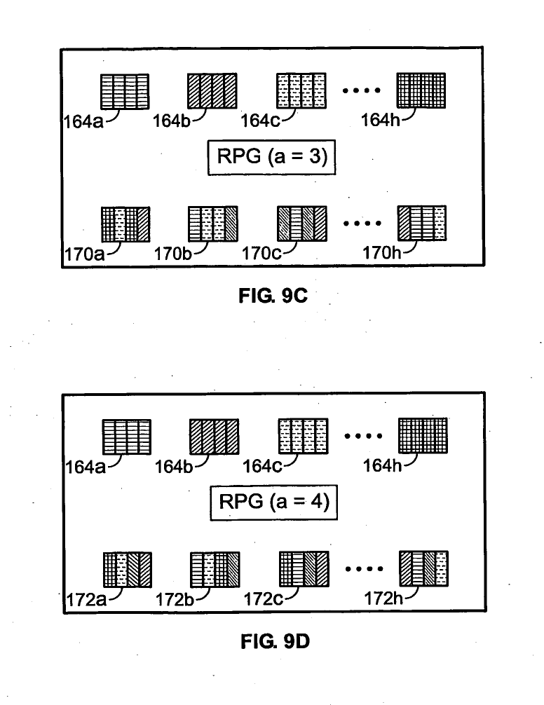

Expressed in another way, the order of permutation a represents the following property of the permuted sub-sub-blocks Cᵢ^{r} as illustrated in FIGS. 9A-9D. The Bᵢ^{r} are represented graphically as eight input sub-sub-blocks 164a-164h each sub-sub-block having four sub-sub-blocks representing four bits of the plaintext all with the same shade of grey. After permutation is performed by the random permutation generator (RPG) 104a (see FIG. 6) with an input of α=1 (see FIG. 9A), then the permuted four bit output sub-sub-blocks 166a-166h (i.e., the Cᵢ^{r}) will each contain bits from at most one of the input sub-sub-blocks 164a-164f, hence each of the output sub-sub-blocks 166a-166h has a single shade of grey for all its bits. After permutation is performed by the random permutation generator (RPG) 104a with an input of α=2 (see FIG. 9B), then the permuted four bit output sub-sub-blocks 168a-168h will each contain bits from two of the input blocks sub-sub-164a-164f, hence each of the output sub-sub-blocks 168a-168h has bits of two shades of grey. After permutation is performed by the random permutation generator (RPG) 104a with an input of α=3 (see FIG. 9C), then the permuted four bit output sub-sub-blocks 170a-170h will each contain bits from three of the input blocks sub-sub-164a-164f, hence each of the output sub-sub-blocks 170a-170h has bits of three shades of grey. After permutation is performed by the random permutation generator (RPG) 104a with an input of α=4 (see FIG. 9D), then the permuted four bit output blocks sub-sub-blocks 172a-172h will each contain bits from four of the input sub-sub-blocks 164a-164f, hence of the each output sub-sub-blocks 172a-172h has bits of four shades of grey. Thus, as the permutation order increases, so does the degree of the avalanche effect, since the probability of output sub-sub-blocks Cₗ^{r} being affected by errors in bits from input sub-sub-blocks Bₗ^{r} increases. Decreasing a below 4 decreases susceptibility to avalanche effect-induced errors.

The Advanced Encryption Standard (AES) is another representative iterated block encryption standard that can benefit from modification to its permutation operations using the SCOPE method of the present invention. A representative description of AES is presented in AES Proposal: Rijndael, Joan Daemon, Vincent Rijman, Document Version 2, 9 Mar. 1999 (hereinafter “the Rijndael AES Cipher”) which can be found at the web site http://csrc.nist.gov/CryptoToolkit/aes/rijndael/Rijndael.pdf and which is incorporated herein by reference in its entirety. The Rijndael AES Cipher describes an iterated block cipher with a variable block length and a variable key length. The block length and the key length can be independently specified to 128, 192, or 256 bits. The different transformations of the Rijndael AES Cipher are performed on an initial block of plaintext and intermediate ciphertext results called the State. The State can be pictured as a rectangular array of bytes. For a block length of 128 bits, the State is arranged as a 4×4 matrix of bytes. Similarly, for a key length of 128 bits, the key, known as a Cipher Key, is similarly arranged as a 4×4 matrix of bytes. The transformations performed on the State matrix can be viewed as a series of matrix multiplications and additions, the rules for the matrix multiplications and additions being described in Section 2 of the Rijndael AES Cipher. The transformations can be described in pseudo C code as:

Rijndael (State, RoundKey)
{

AddRoundKey(State, RoundKey);
For ( i=1; i<Nr; i++)

Round(State, RoundKey);

FinalRound(State, RoundKey);

}

where RoundKey are portions of the Cipher Key generated by the transformations described in Section 3 of the Rijndael AES Cipher. Nr is the number of rounds of transformations to be performed on the State, which depends on the number of rows and columns in the State matrix, which in turn depends on the size of a block. For a block size of 128 bits, Nr=10.

The round transformation is composed of four different transformations. In pseudo C notation these are:

Round(State, RoundKey)
{

ByteSub(State);
ShiftRow(State);
MixColumn(State);
AddRoundKey(State, RoundKey);

}

The final round of the cipher is slightly different, defined in pseudo C notation as:

FinalRound(State, RoundKey)
{

ByteSub(State);
ShiftRow(State);
AddRoundKey(State, RoundKey);

}

ByteSub is a substitution operation performed on each byte of the State matrix using an S-box defined in Section 4.2.1 of the Rijndael AES Cipher. The ShiftRow and MixColumn transformations are both permutation operations. In ShiftRow, the rows of the State are cyclically shifted over different offsets. For a 128 bit block, each row byte of the State matrix, designated S_{4×4}^{r} where r is the round number, is shifted by the corresponding row number to get A_{4×4}^{r}, i.e. the first row is not shifted, the second row is shifted by one byte, the third row by two bytes, and the fourth row by three bytes. In the MixColumn operation, A_{4×4}^{r} is a matrix multiplied by an invertible square matrix (printed below and described in Section 4.2.3 of the Rijndael AES Cipher) to get the resulting State B_{4×4}^{r}.

$$MixColumn Matrix ( encryption ) = [ \begin{matrix}2 & 3 & 1 & 1 \\ 1 & 2 & 3 & 1 \\ 1 & 1 & 2 & 3 \\ 3 & 1 & 1 & 2\end{matrix} ]$$

The MixColumn operation is performed so that every element in B_{4×4}^{r} is dependent on all the elements from the same column of A_{4×4}^{r}. In the AddRoundKey operation, the RoundKey for round r bitwise XOR's the RoundKey with the State.

When the method of the present invention is applied to AES with a block size of 128 bits and a Cipher Key of 128 bits, diffusion is controlled by altering the diffusion of the MixColumn transformations based on its branch number (See Section 7.3.1 of Rijndael AES Cipher for a description of branch number.) and by changing the number of shifts in the ShiftRow transformation. The actions to be performed alter the Round function described above and depend on the user-defined choice of the permutation order α. As with DES, α=1, 2, 3, or 4. The following changes to the Rijndael function are used to get the four orders of permutation:

Rijndael (State, RoundKey, α)
{

AddRoundKey(State, RoundKey);
For ( i=1; i<Nr; i++)

Round(State, RoundKey, α);

FinalRound(State, RoundKey, α);

}

Round(State, RoundKey, α)

{

ByteSub(State);
ShiftRow(State, α);
MixColumn(State, α);
AddRoundKey(State, RoundKey);

}
FinalRound(State, RoundKey, α)
{

ByteSub(State);
ShiftRow(State, α);
AddRoundKey(State, RoundKey);

}

α=1: Both the ShiftRow and MixColumn operations are eliminated.

α=2: The State is divided into four 2×2 matrices. The ShiftRow transformation shifts the second row of each 2×2 matrix by one byte. The MixColumn transformation multiplies the State with a 2×2 matrix having a branch number of 3. The 2×2 matrices with a branch number of 3 are not necessarily the same matrix. The MixColumn 2×2 matrix appears below:

$$MixColumn matrix ( encryption ) = [ \begin{matrix}12 \\ 21\end{matrix} ]$$

α=3: The ShiftRow transformation remains the same as for the case of α=2. The MixColumn transformation is the same transformation used in the Rijndael AES Cipher.

α=4: The ShiftRow and MixColumn transformations, and hence the order of transformation, remain the same as is used in the Rijndael AES Cipher.

As with the DES cipher modified with SCOPE, for the AES cipher modified with SCOPE, when α=4, maximum security is desired so that the default AES algorithm is used. An α of 1 deviates the most from standard AES, with maximum immunity to bit errors but minimum security. The value of α can be selected as desired by the user, but it may also be defined mathematically as follows. The relationship S_{j,i}^{r}→B_{ij,i}^{r} is defined to be true when a change in one or more bits in S_{j,i}^{r} will change one or more bits of B_{j,i}^{r} with a probability p>0. If Π_{j,i}^{r} is the set {S_{j,i}^{r}s.tS_{j,i}^{r}→B_{j,i}^{r} is true}, then the order of permutation α for every element in the ciphertext B_{j,i}^{r} is defined as the cardinality of the set Π_{j,i}^{r}. The ShiftRow and MixColumn transformation matrices are chosen in such a way that the cardinality of all Π_{j,i}^{r} is the same for all i and all j.

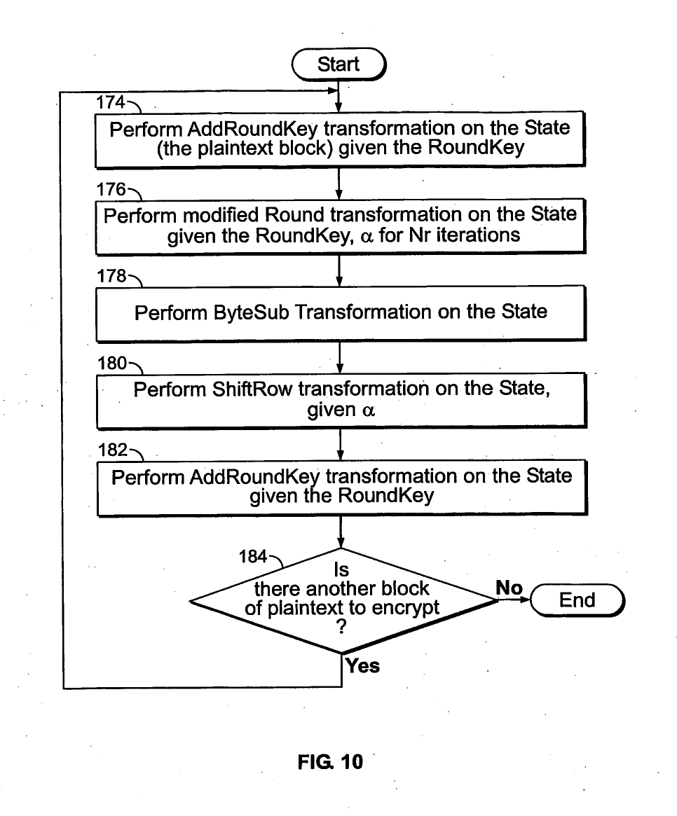

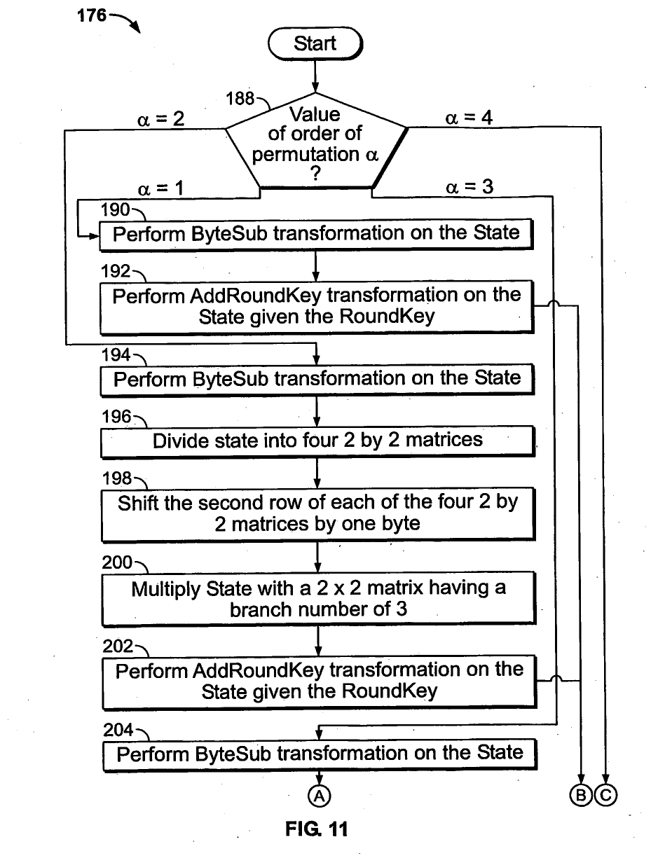

With reference to FIG. 10, there is shown a flow chart of the steps of the SCOPE method applied to an AES encryption procedure. At step 174, the AddRoundKey transformation is performed on the State (the plaintext block) given the RoundKey. At step 176, a modified Round transformation is performed on the State given the RoundKey and α for Nr iterations. The ByteSub and ShiftRow transformations of the Round transformation are modified according to the SCOPE method outlined above. At steps 178-182, the FinalRound transformations are performed on the State given the RoundKey and α. The FinalRound transformation includes the following steps: at step 178, the standard ByteSub transformation is performed on the State; at step 180, the standard ShiftRow transformation is performed on the State given α; and at step 182, an AddRoundKey transformation is performed on the State given the RoundKey. At step 184, if there are other blocks of plaintext to encrypt, then each remaining plaintext block would be encrypted by repeating steps 174-184.

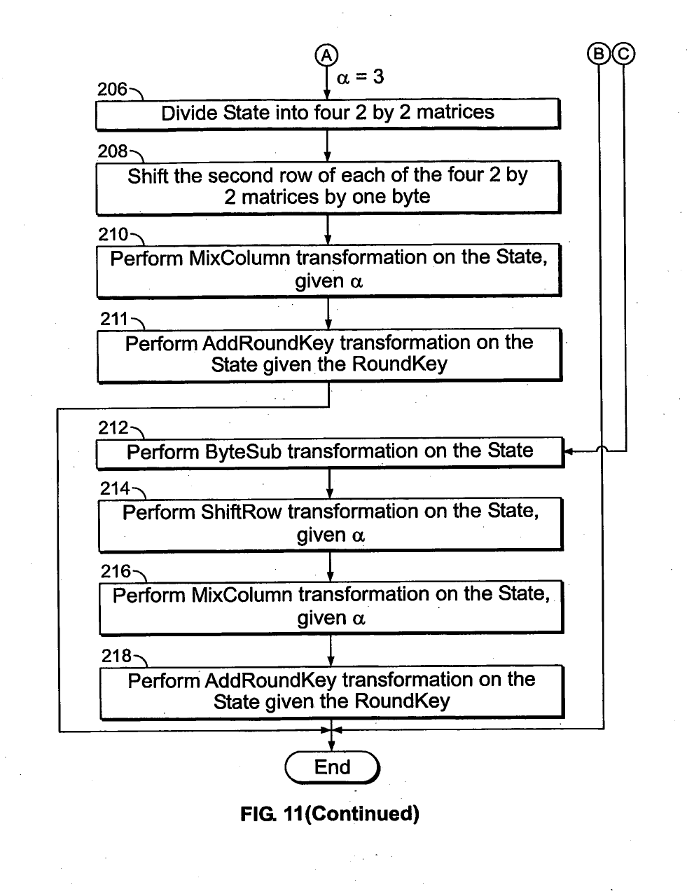

Referring now to FIG. 11, the modified Round transformation is shown in greater detail. At step 188, if the order of permutation α is set to 1, then at step 190, the ByteSub transformation is performed on the State, followed, at step 192, with performing the AddRoundKey transformation on the State given the RoundKey. If at step 188, the order of permutation α was set to 2, then at step 194, the ByteSub transformation is performed on the State. Then, the modified ShiftRow transformation is performed on the State, in which, at step 196, the State is divided into four 2 by 2 matrices, followed at step 198 by shifting the second row of each of the four 2 by 2 matrices by one byte. At step 200, the modified MixColumn transformation is performed on the state, in which the State is multiplied with a 2×2 matrix having a branch number of 3. At step 202, the AddRoundKey transformation is performed on the State given the RoundKey. If at step 188, the order of permutation α was set to 3, then at step 204, the ByteSub transformation is performed on the State. Then, the modified ShiftRow transformation is performed on the State, in which, at step 206, the State is divided into four 2 by 2 matrices, followed at step 208 by shifting the second row of each of the four 2 by 2 matrices by one byte. At step 210, the standard MixColumn transformation is performed on the State given α. Then, at step 211, the addRoundKey transformation is performed on the State given the RoundKey. At step 188, if the order of permutation α is set to 4, then at step 212, the ByteSub transformation is performed on the State. At step 214, the standard ShiftRow transformation is performed on the State given α. At step 216, the MixColumn transformation is performed on the State given α. At step 218, the addRoundKey transformation is performed on the State given the RoundKey.

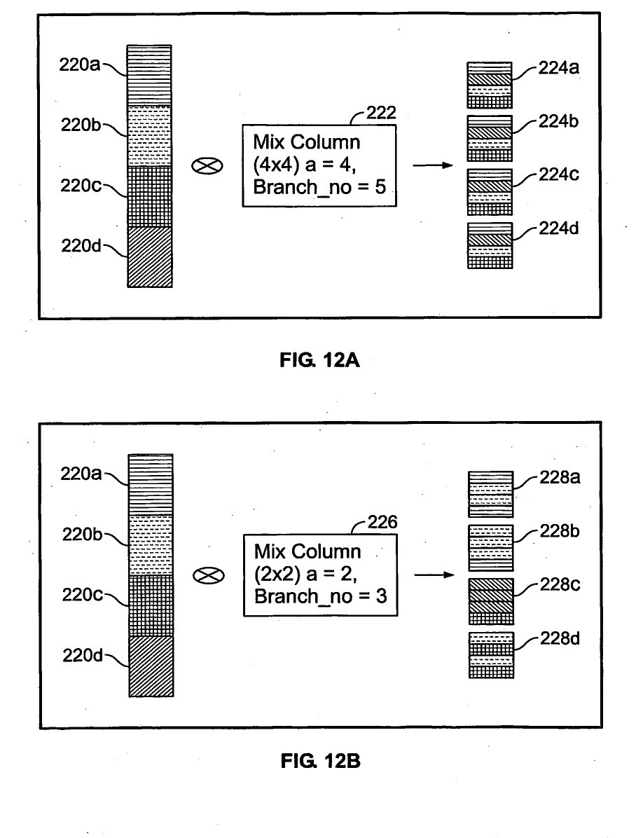

Expressed in another way, the order of permutation α represents the following property of the MixColumn transformation on the State matrix as illustrated in FIGS. 12A, 12B. The four bytes 220a-220d are bytes of different shades of grey of the first column of four bytes of the State matrix. For the case of α=4 and branch number=5, the MixColumn transformation 222 produces four output bytes 224a-224d, each containing four different shades of grey, indicating that bits from all four input bytes 220a-220d influence each of the output bytes 224a-224d. The same logic applies to the other three columns of bytes from the State matrix. Similarly for the case of α=2 and branch number=3, the MixColumn transformation 226 produces four output bytes 228a-228d, each containing two different shades of grey, indicating that bits from two of the input bytes 220a-220d influence each of the output bytes 228a-228d. Similarly, for α=1 and α=3 (not shown), bits from one input byte and bits from three output bytes affect the output bytes, respectively. Thus, as for the SCOPE-modified DES cipher of the present invention, so for the SCOPE-modified AES cipher, as the permutation order increases, so does the degree of the avalanche effect, since the probability of output bytes being affected by errors in bits from input bytes increases. Decreasing α below 4 decreases susceptibility to avalanche effect-induced errors.

The decryption operation for SCOPE applied to AES employs modifications to the standard inverse Rijndael cipher (as described in Section 5.3 thereof). The SCOPE description operation can be described in pseudo-C code as follows:

InvRijndael (State, RoundKey, α)
{

InvFinalRound(State, RoundKey, α);
For ( i=1; i<Nr; i++)

InvRound(State, RoundKey, α);

AddRoundKey(State, RoundKey);

}
InvRound(State,RoundKey,α)
{

AddRoundKey(State,RoundKey);
InvMixColumn(State,α);
InvShiftRow(State,α);
InvByteSub(State);

}
InvFinalRound(State,RoundKey,α)
{

AddRoundKey(State,RoundKey);
InvShiftRow(State,α);
InvByteSub(State);

}

α=1: Both the InvShiftRow and InvMixColumn operations are eliminated.

α=2: The State is divided into four 2×2 matrices. The InvShiftRow transformation shifts the second row of each 2×2 matrix by one byte (same as encryption). The InvMixColumn transformation multiplies the State with a 2×2 matrix having a branch number of 3. The 2×2 matrices with a branch number of 3 are not necessarily the same matrix. The InvMixColumn 2×2 matrix can be expressed as:

$$InvMixColumn matrix ( decryption ) = [ \begin{matrix}167 & 83 \\ 83 & 167\end{matrix} ]$$

α=3: The InvShiftRow transformation remains the same as for the case of α=2. The InvMixColumn transformation is the same transformation used in the Rijndael AES Cipher, except that the inverse matrix is changed as shown below:

$$InvMixColumn matrix ( decryption ) = [ \begin{matrix}14 & 11 & 13 & 9 \\ 9 & 14 & 11 & 13 \\ 13 & 9 & 14 & 11 \\ 11 & 13 & 9 & 14\end{matrix} ]$$

α=4: The InvShiftRow and InvMixColumn transformations, and hence the order of transformation, remain the same as is used in the Rijndael AES inverse Cipher (using the same inverse matrix as when α=3).

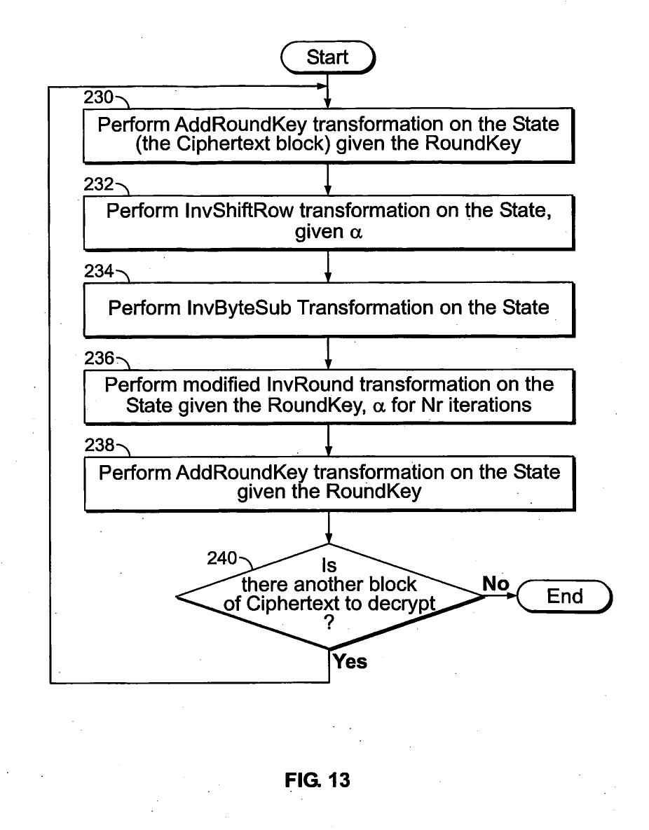

With reference to FIG. 13, there is shown a flow chart of the steps of the SCOPE method applied to a AES decryption procedure. At steps 230-234, the InvFinalRound transformations are performed on the State (the ciphertext block) given the RoundKey and α. The InvFinalRound transformation includes the following steps: At step 230, an AddRoundKey transformation is performed on the State given the RoundKey. At step 232, the InvShiftRow transformation is performed on the State given α. At step 234, the standard InvByteSub transformation is performed on the State. At step 236, a modified InvRound transformation is performed on the State given the RoundKey and α for Nr iterations. The InvByteSub and InvShiftRow transformations of the InvRound transformation are modified according to the SCOPE method outlined above. At step 238, the AddRoundKey transformation is performed on the State given the RoundKey. At step 240, if there are other blocks of ciphertext to decrypt, then each remaining ciphertext block would be decrypted by repeating steps 230-240.

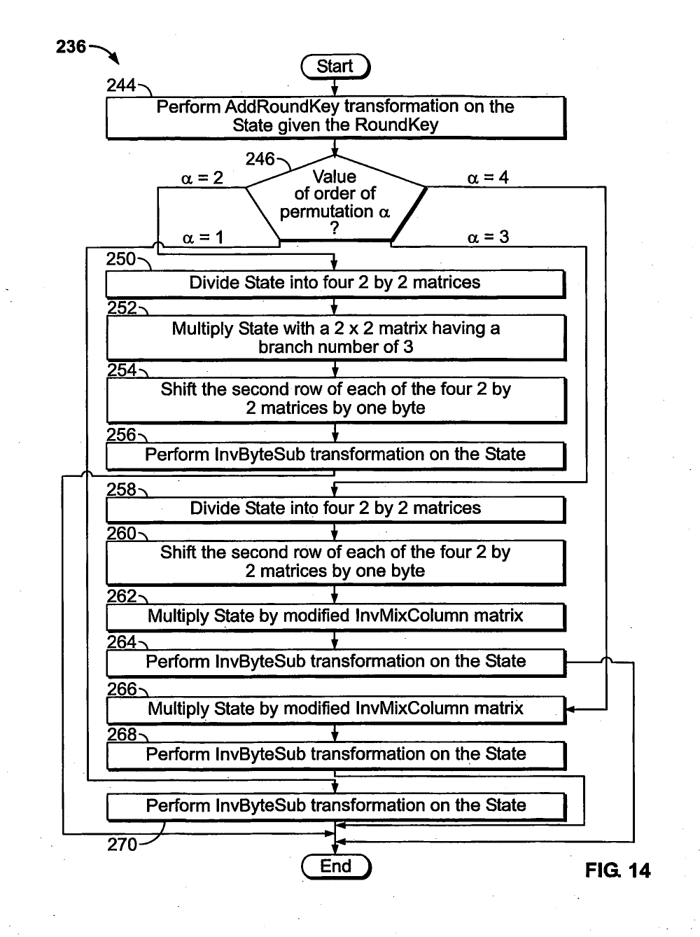

Referring now to FIG. 14, the modified InvRound transformation is shown in greater detail. At step 244, the addRoundKey transformation is performed on the State given the RoundKey. At step 246, if the order of permutation a is set to 1, then at step 270, the InvByteSub transformation is performed on the State. If at step 246 the order of permutation a was set to 2, then at step 250, the State is divided into four 2 by 2 matrices. At step 252, the modified InvMixColumn transformation is performed on the state, in which the State is multiplied with a 2×2 matrix having a branch number of 3, in which the 2×2 matrix is the matrix described above. Then, the modified InvShiftRow transformation is performed on the State, in which, at step 254, the second row of each of the four 2 by 2 matrices is shifted by one byte. At step 256, the InvByteSub transformation is performed on the State. If at step 246 the order of permutation a was set to 3, then at step 258, the State is divided into four 2 by 2 matrices, followed at step 260 by shifting the second row of each of the four 2 by 2 matrices by one byte. At step 262, the State is multiplied by the modified 4×4 InvMixColumn matrix described above. At step 264, the InvByteSub transformation is performed on the State. At step 246, if the order of permutation a is set to 4, then at step 266, the State is multiplied by the modified 4×4 InvMixColumn matrix described above. At step 268, the InvByteSub transformation is performed on the State.

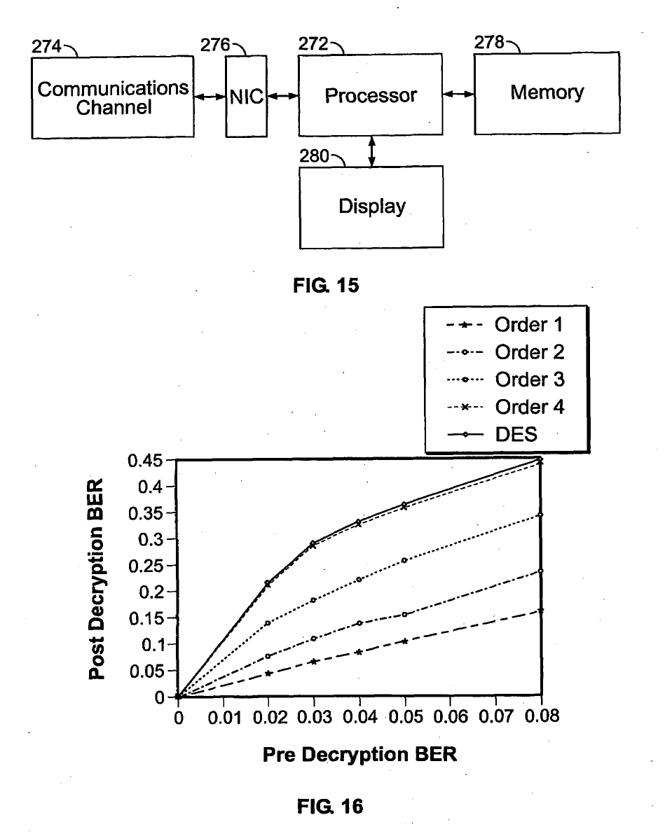

With reference to FIG. 15, an apparatus implementing the method of the present invention is depicted. A processor 272 reads in the data to be encrypted or decrypted from communications channel 274 via a network interface card (NIC) 276 and stores the image in memory 278. Communications channel 274 is often a local area network or the Internet, so that the network interface card (NIC) 276 can be an Ethernet Card. In wireless communications, the communication channel 274 is a Radio Frequency (RF) link, and the network interface card (NIC) 276 is a WiFi, Bluetooth, cellular, or other wireless transceiver. In still other applications, communications channel 274 is a telecommunication network and NIC 276 is a dial-up, DSL, or cable modem. The processor 272 can reside within an embedded system, a personal computer, work station, a minicomputer, or a main frame. Memory 278 includes a main memory, which may include both volatile and non-volatile memory, such as random access memory (RAM) and read-only memory (ROM). The memory 278 may also include secondary storage in the form of long-term storage mediums such as hard disks, floppy disks, tape, compact disks (CDs, DVDs), flash memory, and other devices that store data using electrical, magnetic, optical or other recording media. The memory 278 may also include video display memory for displaying images on a display 280, such as a monitor. The memory 278 can comprise a variety of alternative components having a variety of storage capacities such as magnetic cassettes, memory cards, video digital disks, random access memories, read-only memories and the like. Memory devices within the memory 278 and their associated computer readable media provide non-volatile storage of computer readable instructions, data structures, programs and other data such as that used in implementing the method of the present invention. The memory 278 may also be used for storing the data to be encrypted/decrypted as received from the communication channel 274. If the processor 272 is decrypting a video image, the decrypted image can be shown on the display 280, stored back in the memory 278, or sent back over the communication channel 274 via the network interface card (NIC) 276.

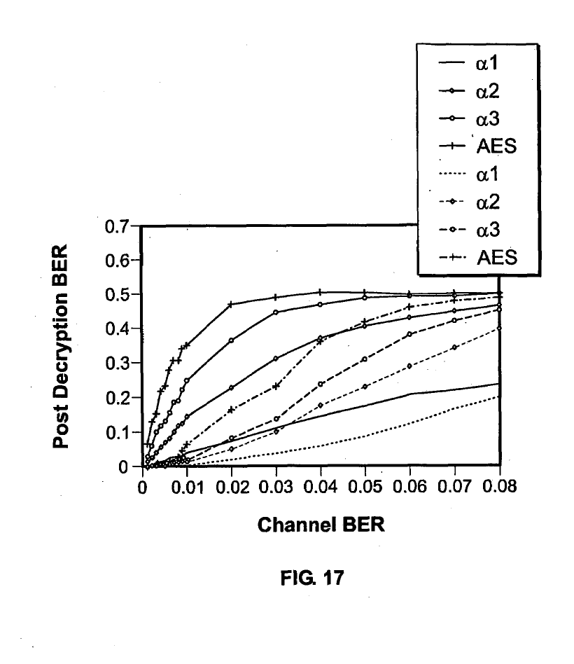

The present invention has several advantages over the prior art iterated block ciphers. For instance, using the SCOPE-modified DES/AES cipher improves image quality for video images compared to using the standard DES/AES cipher. With reference to FIGS. 16 and 17, pre-decryption bit error rates are plotted vs. post-decryption bit error rates using the unaltered DES cipher and the SCOPE-modified DES cipher, and using the unaltered AES cipher and the SCOPE-modified AES cipher, respectively, for different values of α. The data plotted for FIGS. 16 and 17 were generated from data obtained from the following experimental setup. A digital video image was encrypted using 16 rounds of standard DES or SCOPE-modified DES for FIG. 16, and 10 rounds of standard AES and SCOPE-modified AES for FIG. 17. The encrypted data was then channel coded using convolution codes. The encrypted and convolutionally encoded image data was transmitted through a binary symmetric channel. At the receiver, the encoded data was channel decoded using a Viterbi decoder. Then the data was decrypted using the SCOPE-modified DES or AES ciphers to get the original image. The convolution codes used a rate of ½.

For both FIGS. 16 and 17, channel errors were varied from 0 to 10⁻¹ bit error rate (BER). The data was then Viterbi decoded after which the pre-decryption BERs ranged from 0 to 8×10⁻². In FIG. 17, the dotted graphs denote the performance of the modified AES cipher with channel coding (convolution codes with a rate of ½). In general, the BERs of decrypted data were higher for the standard ciphers than for the SCOPE-modified ciphers. For example, using the SCOPE-modified DES cipher produced a 66% reduction in errors for a pre-decryption error rate of 0.08. Using the SCOPE-modified AES cipher produced a 52% reduction in errors for a pre-decryption error rate of 0.08.

Because of the reduction of BER, the present invention can improve Quality of Service (QOS) in secure communications. Fewer bit errors decrease retransmissions and thus conserve battery power for wireless communications such as in biological sensor networks. When a SCOPE-modified block cipher is used for encryption/decryption, no specialized hardware or complex software is required. The present invention is applicable to emerging IEEE 802.11i (WPA2) WiFi security using SCOPE-modified AES encryption. The present invention can be used for application-layer encryption such as secure MPEG-4 video streaming over wireless networks.

The present invention is susceptible to numerous modifications and variations. For DES-like encryption ciphers or AES ciphers with more than 128 bit blocks, the number of allowed values of α can be increased proportionately. The value of α is under user (program) control, so there are circumstances that would lend themselves to greater control over the level of robustness vs. security on a per-block basis. Examples include motion video, where portions of the video screen that have more motion will need higher security and thus greater values of α. Depending on the channel conditions and the priority of the data, data can be permuted to different extents. For example, if the channel is not very noisy, then α is increased and vice versa. In situations where is necessary to reduce α, then the SCOPE-modified ciphers of the present invention can be combined with error correction codes to improve robustness to errors while maintaining high security. With appropriate modifications to the operations and transformations that cause diffusion, SCOPE-modified is applicable to any iterated block cipher.

It will be understood that the embodiments described herein are merely exemplary and that a person skilled in the art may make many variations and modifications without departing from the spirit and scope of the invention. All such

1. A method for maintaining data integrity for a block of data to be transmitted over a communications channel, comprising the steps of:
(a) receiving a block of data to be encrypted;
(b) selecting an iterated block cipher encryption algorithm to be applied to the block of data;
(c) determining a desired amount of diffusion specified by a user;
(d) selecting a diffusion function corresponding to the desired amount of diffusion; and
(e) encrypting the block of data using the iterated block cipher encryption algorithm and the diffusion function to produce a cipher text for transmission over the communications channel.

2. The method of claim 1, further comprising the step of: (f) transmitting the cipher text over the communications channel.

3. The method of claim 2, further comprising the step of: (g) receiving and decrypting the cipher text using a corresponding iterated block cipher decryption algorithm modified by the same diffusion function corresponding to the desired amount of diffusion used during encryption.

4. The method of claim 1, wherein the amount of diffusion is an order of permutation.

5. The method of claim 4, further comprising the step of:
(f) replacing expansion bits of the iterated block cipher encryption algorithm with a minicipher if the iterated block cipher encryption algorithm contains an expansion operation.

6. The method of claim 5, further comprising the step of:
(g) replacing a permutation box used in the iterated block cipher encryption algorithm with a modified permutation box generated by a random permutation generator.

7. The method of claim 6, further comprising the steps of:
(h) initializing a secret key, an optional initialization vector, and a seed value;
(i) generating the permutation box using the random permutation generator initialized with the seed value and the desired order of permutation; and
(j) if the iterated block cipher encryption algorithm contains an expansion operation, generating expansion bits using a minicipher.

8. The method of claim 7, further comprising the step of:
(k) changing the order of permutation after the step of encrypting the block of data if there is another block of data to be encrypted in a message.

9. The method of claim 7, wherein the iterated block cipher encryption algorithm is a DES-based encryption algorithm.

10. The method of claim 9, further including the steps of:
(l) initializing a variable counter;
(m) initializing the minicipher with the initialization vector to produce an initial value of the minicipher;
(n) generating output bits of the minicipher;
(o) dividing the block of data into a 32-bit left-half sub-block and a 32-bit right half sub-block;
(p) permuting said 32-bit right-half sub-block with an initial permutation used in the standard DES algorithm before step (f);
(q) using the minicipher to expand said 32-bit right-half sub-block of the block of data into a 48-bit expanded sub-block;
(r) modulo-2 summing the expanded sub-block with a 48-bit portion of the key;
(s) substituting the 48-bit expanded sub-block with an S-box to convert the 48-bit expanded sub-block back to a 32-bit substituted sub-block;
(t) permuting the 32-bit substituted sub-block with the modified permutation box to produce a permuted sub-block;
(u) modulo-2 summing the permuted sub-block with said 32-bit left-half sub-block; and
(v) swapping the 32-bit left-half sub-block with the 32-bit right half sub-block.

11. The method of step 10, further including the step of:
(w) repeating steps (p)-(v) for 14 rounds;
(x) repeating steps (p)-(u) to produce a combined block; and
(y) permuting the combined block with an inverse permutation block of the standard DES algorithm to produce the cipher text.

12. The method of claim 11, further including the steps of, if there is another plaintext block to encrypt:
(z) incrementing the variable counter;
(aa) XORing the counter with output bits of the minicipher; and
(bb) choosing an order of permutation.

13. The method of claim 12, further including the step of:
(cc) repeating steps (n)-(y) for another block of plaintext.

14. The method of claim 10, wherein step (n) further includes the steps of:
expanding the initial value of the minicipher from 16 bits to 24 bits using an expansion box to produce an expanded minicipher;
substituting bits of the expanded minicipher with four substitution boxes to produce a 16-bit substituted minicipher;
permuting bits of the 16-bit substituted minicipher to produce a 16-bit permuted minicipher; and
bitwise XORing the 16-bit permuted minicipher with the variable counter to produce the output bits of the minicipher.

15. The method of claim 6, wherein the iterated block cipher encryption algorithm is an AES-based encryption algorithm.

16. The method of claim 15, wherein the iterated block cipher encryption algorithm is a Rijndael AES-based encryption algorithm with a block size of 128 bits and a cipher key of 128 bits.

17. The method of claim 16, wherein the State is a block of plaintext as represented in a Rijndael AES-based encryption algorithm, and wherein step (g) further includes the steps of:
(h) performing the AddRoundKey transformation on the State given a RoundKey;
(i) performing a modified Round transformation on the State given the RoundKey and the order of permutation for 10 iterations, wherein the modified Round transformation includes the steps of altering the diffusion of a MixColumn transformation based on its branch number; and changing the number of shifts in a ShiftRow transformation.
(j) performing a FinalRound transformation on the State given the RoundKey and the order of permutation.

18. The method of claim 17, further including the step of repeating steps (h)-(j) for subsequent blocks of plaintext.

19. The method of claim 18, wherein the order of permutation includes integer values in the range of 1-4.

20. The method of claim 19, wherein step (i) further includes the steps of, when the order of permutation is equal to 1:
(k) performing a ByteSub transformation on the State; and
(l) performing an AddRoundKey transformation on the State given the RoundKey.

21. The method of claim 20, wherein step (i) further includes the steps of, when the order of permutation is equal to 2:
(k) performing a ByteSub transformation on the State;
(l) dividing the State into four 2 by 2 matrices;
(m) shifting the second row of each of the four 2 by 2 matrices by one byte;
(n) multiplying the State with a 2×2 matrix having a branch number of 3; and
(o) performing an AddRoundKey transformation on the State given the RoundKey.

22. The method of claim 21, wherein step (i) further includes the steps of, when the order of permutation is equal to 3:
(k) performing a ByteSub transformation on the State;
(l) dividing the State into four 2 by 2 matrices;
(m) shifting the second row of each of the four 2 by 2 matrices by one byte;
(n) performing a MixColumn transformation on the State; and
(o) performing an AddRoundKey transformation on the State given the Round Key.

23. The method of claim 22, wherein step (i) further includes the step of, when the order of permutation is equal to 4:
(k) performing the standard Rijndall AES Round transformation on the State given the RoundKey for 10 iterations.

24. A method for decrypting data transmitted over a communications channel while maintaining data integrity, comprising the steps of:
(a) receiving a block of ciphertext to be decrypted;
(b) selecting an iterated block cipher decryption algorithm to be applied to the block of ciphertext, the iterated block cipher decryption algorithm modified by a diffusion function corresponding to a desired amount of diffusion used during encryption; and
(c) decrypting the block of ciphertext using the iterated block cipher decryption algorithm and the diffusion function to produce a block of plaintext.

25. The method of claim 24, wherein the amount of diffusion is an order of permutation.

26. The method of claim 25, further comprising the step of:
(d) replacing expansion bits of the iterated block cipher decryption algorithm with a minicipher if the iterated block cipher decryption algorithm contains an expansion operation.

27. The method of claim 26, further comprising the step of:
(e) replacing a permutation box used in the iterated block cipher decryption algorithm with a modified permutation box generated by a random permutation generator.

28. The method of claim 27, further comprising the steps of:
(f) receiving a secret key, an optional initialization vector, and a seed value;
(g) generating the permutation box using the random permutation generator which is initialized with the seed value and using the desired order of permutation; and
(h) if the iterated block cipher encryption algorithm contains an expansion operation, generating expansion bits using a minicipher.

29. The method of claim 28, further comprising the step of:
(i) changing the order of permutation after the step of decrypting the block of data if there is another block of data to be decrypted in a message.

30. The method of claim 28, wherein the iterated block cipher encryption algorithm is a DES-based encryption algorithm.

31. The method of claim 30, further including the steps of:
(j) initializing a variable counter;
(k) initializing the minicipher with the initialization vector to produce an initial value of the minicipher;
(l) generating output bits of the minicipher;
(m) dividing the block of data into a 32-bit left-half sub-block and a 32-bit right half sub-block; and
(n) permuting said 32-bit right-half sub-block with an initial permutation used in the standard DES algorithm before step (d);
(o) using the minicipher to expand said 32-bit right-half sub-block of the block of data into a 48-bit expanded sub-block:
(p) modulo-2 summing the expanded sub-block with a 48-bit portion of the key;
(q) substituting the 48-bit expanded sub-block with an S-box to convert the 48-bit expanded sub-block back to a 32-bit substituted sub-block;
(r) permuting the 32-bit substituted sub-block with the modified permutation box to produce a permuted sub-block;
(s) modulo-2 summing the permuted sub-block with said 32-bit left-half sub-block; and
(t) swapping the 32-bit left-half sub-block with the 32-bit right half sub-block.

32. The method of step 31, further including the step of:
(u) repeating steps (n)-(s) for 14 rounds;
(v) repeating steps (n)-(s) to produce a combined block; and
(w) permuting the combined block with an inverse permutation block of the standard DES algorithm to produce the plaintext.

33. The method of claim 32, further including the steps of, if there is another ciphertext block to decrypt:
(x) incrementing the variable counter;
(y) XORing the counter with output bits of the minicipher; and
(z) choosing an order of permutation.

34. The method of claim 32, further including the step of:
(aa) repeating steps (l)-(w) for the another block of plaintext.

35. The method of claim 31, wherein step (l) further includes the steps of:
expanding the initial value of the minicipher from 16 bits to 24 bits using an expansion box to produce an expanded minicipher;
substituting bits of the expanded minicipher with four substitution boxes to produce a 16-bit substituted minicipher;
permuting bits of the 16-bit substituted minicipher to produce a 16-bit permuted minicipher; and
bitwise XORing the 16-bit permuted minicipher with the variable counter to produce the output bits of the minicipher.

36. The method of claim 28, wherein the iterated block cipher decryption algorithm is an AES-based decryption algorithm.

37. The method of claim 36, wherein the iterated block cipher decryption algorithm is a Rijndael AES-based decryption algorithm with a block size of 128 bits and a cipher key of 128 bits.

38. The method of claim 37, wherein the State is a block of ciphertext as represented in the Rijndael AES-based decryption algorithm, and wherein step (e) further includes the steps of:
(f) performing an InvFinalRound transformation on the State given the RoundKey and the order of permutation.
(g) performing a modified InvRound transformation on the State given the RoundKey and the order of permutation for 10 iterations, wherein the modified InvRound transformation includes the steps of altering the diffusion of a InvMixColumn transformation based on its branch number; and changing the number of shifts in a InvShiftRow transformation.
(h) performing the AddRoundKey transformation on the State given a RoundKey;

39. The method of claim 38, further including the step of, if there are other blocks of ciphertext to decrypt: repeating steps (f)-(h) for the another block of plaintext.

40. The method of claim 38, wherein the order of permutation includes integer values in the range of 1-4.

41. The method of claim 40, wherein step (g) further includes the steps of, when the order of permutation is equal to 1:
(i) performing an AddRoundKey transformation on the State given the RoundKey.
(j) performing a InvByteSub transformation on the State.

42. The method of claim 40, wherein step (g) further includes the steps of, when the order of permutation is equal to 2:
(i) performing an AddRoundKey transformation on the State given the RoundKey;
(j) dividing the State into four 2 by 2 matrices;
(k) shifting the second row of each of the four 2 by 2 matrices by one byte;
(l) multiplying the State with a 2×2 matrix having a branch number of 3; and
(m) performing an InvByteSub transformation on the State.

43. The method of claim 42, wherein the 2×2 matrix having a branch number of 3 is expressed as
$$[ \begin{matrix}167 & 83 \\ 83 & 167\end{matrix} ] .$$

44. The method of claim 40, wherein step (g) further includes the steps of, when the order of permutation is equal to 3:
(i) performing an InvMixColumn transformation on the State, wherein the InvMixColumn transformation matrix is replaced by the following matrix expressed as
$$[ \begin{matrix}14 & 11 & 13 & 9 \\ 9 & 14 & 11 & 13 \\ 13 & 9 & 14 & 11 \\ 11 & 13 & 9 & 14\end{matrix} ] ;$$
(j) dividing the State into four 2 by 2 matrices;
(k) shifting the second row of each of the four 2 by 2 matrices by one byte; and
(l) performing an InvByteSub transformation on the State.

45. The method of claim 40, wherein step (g) further includes the step of, when the order of permutation is equal to 4:
(l) performing the standard Rijndall AES InvRound transformation on the State given the RoundKey for 10 iterations, wherein the InvMixColumn transformation matrix is replaced with the following matrix expressed as
$$[ \begin{matrix}14 & 11 & 13 & 9 \\ 9 & 14 & 11 & 13 \\ 13 & 9 & 14 & 11 \\ 11 & 13 & 9 & 14\end{matrix} ] .$$

46. An apparatus for encrypting a block of data while maintaining data integrity, comprising:
a memory for storing a user specified desired amount of diffusion; and
a processor for
receiving a block of data to be encrypted from said memory;
selecting an iterated block cipher encryption algorithm from said memory to be applied to said block of data;
selecting a diffusion function from said memory corresponding to the desired amount of diffusion; and
encrypting said block of data using said iterated block cipher encryption algorithm and the diffusion function to produce a cipher text.

47. The apparatus of claim 46, further comprising a network interface card for receiving said cipher text from said processor and for transmitting said cipher text over a communications channel.

48. The apparatus of claim 47, further comprising a second processor for receiving said cipher text from said communications channel and for decrypting the cipher text using a corresponding iterated block cipher decryption algorithm modified by the same diffusion function corresponding to the desired amount of diffusion used during encryption.

49. The apparatus of claim 47, wherein the amount of diffusion is an order of permutation.

50. The apparatus of claim 49, wherein the processor replaces expansion bits of the iterated block cipher encryption algorithm with a minicipher if the iterated block cipher encryption algorithm contains an expansion operation.

51. The apparatus of claim 50, wherein the processor replaces a permutation box used in the iterated block cipher encryption algorithm with a modified permutation box generated by a random permutation generator.

52. The apparatus of claim 51, wherein the processor changes the order of permutation after encrypting the block of data if there is another block of data to be encrypted in a message.

53. The apparatus of claim 52, wherein the processor changes the order of permutation based on conditions in said communications channel.

54. The apparatus of claim 51, wherein the iterated block cipher encryption algorithm is a modified DES-based encryption algorithm.

55. The apparatus of claim 52, wherein the iterated block cipher encryption algorithm is a modified Rijndael AES encryption algorithm with a block size of 128 bits and a cipher key of 128 bits.

56. An apparatus for decrypting a block of data while maintaining data integrity, comprising:
a memory for storing a user specified desired amount of diffusion; and
a processor for:
receiving a block of data to be decrypted from said memory;
selecting an iterated block cipher decryption algorithm from said memory to be applied to said block of data;
selecting a diffusion function from said memory corresponding to the desired amount of diffusion; and
decrypting said block of data using said iterated block cipher decryption algorithm and the diffusion function to produce a plaintext text.

57. The apparatus of claim 56, further comprising a network interface card for receiving said block of data.

58. The apparatus of claim 56, wherein the amount of diffusion is an order of permutation.

59. The apparatus of claim 58, wherein the processor replaces expansion bits of the iterated block cipher decryption algorithm with a minicipher if the iterated block cipher decryption algorithm contains an expansion operation.

60. The apparatus of claim 59, wherein the processor replaces a permutation box used in the iterated block cipher decryption algorithm with a modified permutation box generated by a random permutation generator.

61. The apparatus of claim 60, wherein the processor changes the order of permutation after decrypting the block of data if there is another block of data to be decrypted in a message.

62. The apparatus of claim 61, wherein the iterated block cipher decryption algorithm is a modified DES-based decryption algorithm.

63. The apparatus of claim 61, wherein the iterated block cipher decryption algorithm is a modified Rijndael AES decryption algorithm with a block size of 128 bits and a cipher key of 128 bits.
